(19) United States
(12) Patent Application Publication
(10) Pub. No.: US 2010/0138347 A1
(43) Pub. Date: Jun. 3, 2010

(54) Account Transaction Management Using Dynamic Account Numbers

(75) Inventor: Yingwei Chen, Hangzhou (CN)

Correspondence Address: LEE & HAYES, PLLC, 601 W. RIVERSIDE AVENUE, SUITE 1400, SPOKANE, WA, 99201, US

(73) Assignee: ALIBABA GROUP HOLDING CAPITAL PLACE

(21) Appl. No.: 12/598,617

(22) PCT Filed: Oct. 28, 2008
(86) PCT No.: PCT/US08/81448

§ 371 Date: Nov. 3, 2009

(30) Foreign Application Priority Data
Oct. 30, 2007 (CN) 200710166034.8

(51) Int. Cl. G06Q 40/00; H04L 9/32

(52) U.S. Cl. 705/44; 705/39; 455/466; 726/7

(57) ABSTRACT

A method and a system for managing account transactions aim to effectively prevent account information from being compromised. The system generates a dynamic account number corresponding to a true account number of an account of a user and sends the dynamic account number to the user. The system stores the corresponding relationship between the true account number and the dynamic account number. The system conducts an account transaction requested by the user according to the dynamic account number supplied by the user and the corresponding relationship. The account can be a bank account, and the dynamic account number may be valid for a one-time use or set to expire after a certain period of time or a certain number of uses. The method and the system can make account transactions more reliable and safer, and effectively prevent user account information from malicious access.

### RELATED APPLICATIONS

The present application claims priority benefit of Chinese patent application No. 200710166034.8, filed Oct. 30, 2007, entitled “SYSTEM AND METHOD FOR CONDUCTING ACCOUNT TRANSACTIONS”, which Chinese application is hereby incorporated in its entirety by reference.

### BACKGROUND

The present disclosure relates to the fields of network security technologies, and particularly to methods and systems for account transactions.

Internet and Internet-based applications, services as well as functions have been globally expanding at a tremendous pace. Both newly developed industries and traditional industries are becoming more and more reliant on the Internet. Some of these industries and systems have sensitive information such as electronic commerce, financial services and government affairs. Because the Internet is very different from traditional environments, many malice and even illegal Internet-based behaviors have been spreading with little restriction. The damages arising such activities have become very serious, and severely hinder the further development of the Internet and the Internet-based applications, services and functions.

Among various illegal Internet-based attacks, illegal acquisition of account information of others has been on the rise. Using methods such as virus, Trojans, frauds and phishing, for example, unauthorized persons can obtain the bank account information of other people and steal money from their accounts. Similar to the bank account information, other Internet-based applications are also facing the same threat of illegal attacks.

In order to solve these problems effectively, proposals such as digital certificates and dynamic passwords have been suggested recently. These proposals can reduce to a certain extent the damages arising from these illegal behaviors, but for various reasons, problems still exist. Although digital certificate can protect an account of a user and effectively prevent losses due to a leak of the account information, it is very complicated to maintain a digital certificate and as a result the method is not very well suitable for ordinary people in practice. Moreover, the cost to set up and maintain a digital certificate system is relatively high. Dynamic password refers to a method in which a group of dynamic passwords are pre-generated by the system and sent to the user in the form of dynamic password sheet or a dynamic password card. When the user needs to conduct an account transaction, the user can select a password out of these dynamic passwords as the account password for the present transaction. Since a dynamic password expires after a one-time use, this method can effectively prevent user account from damages owing to virus, Trojans, phishing and the like. However, with the techniques of dynamic passwords commonly adopted today, if a dynamic password of the user is lost or leaked, it may pose a serious threat to the safety of its account. Normally, the account information of a user is not reliably protected against anyone who possesses a right password. If someone illegally obtains the user's password, the perpetrator can easily obtain the account information of the rightful user and take control of the account.

### SUMMARY

Disclosed are a method and a system for managing account transactions aiming to more effectively prevent account information from being stolen. The exemplary embodiments of the method and the system generate a dynamic account number corresponding to the true account number of a user account and send the dynamic account number to the user. The exemplary embodiments also store the corresponding relationship between the true account number and the dynamic account number. An account transaction is conducted based on the dynamic account number provided by the user and the corresponding relationship. Using the disclosed method and system, account transaction can be processed more safely, and the account information is effectively prevented from being stolen.

One aspect of the disclosure is an account transaction management system which has a dynamic account number generating unit used for generating a dynamic account number corresponding to a true account number of an account of a user; a dynamic account number sending unit used for sending the dynamic account number to the user or printing out the dynamic account number; a user account information database used for storing a corresponding relationship between the true account number and the dynamic account number; and a dynamic account number processing unit used for processing an account transaction according to the dynamic account number provided by the user and the corresponding relationship between the true account number and the dynamic account number.

Another aspect of the disclosure is an account transaction management method. The method generates a dynamic account number corresponding to a true account number of an account of a user; sends the dynamic account number to the user; stores a corresponding relationship between the true account number and the dynamic account number; and conducts an account transaction according to the dynamic account number supplied by the user and the corresponding relationship.

Another aspect of the disclosure is one or more computer-readable media storing computer-executable instructions that, when executed, perform the acts of the account transaction management method described herein.

The account can be a bank account. The dynamic account number may be valid for a one-time use or set to expire after a certain period of time or a certain number of uses. In one embodiment, the dynamic account number is sent to a mobile phone of the user. The dynamic account number can be sent to the user using text messaging, e-mail, regular mail, voice messaging, personal contact, or any combination thereof. Multiple dynamic account numbers can be generated in correspondence to a single true account number. These dynamic account numbers may either be pre-generated for a given account, or generated in response to a user request. The dynamic account numbers may be sent to the user one at a time or in groups.

The method and the system can make account transactions more reliable and safer, and effectively prevent user account information from malicious modification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures.

FIG. 1 shows a structural schematic diagram of an account transaction management system in accordance with an exemplary embodiment of the disclosed account transaction management system.

FIG. 2 shows a structural schematic diagram of a dynamic account number processing unit in accordance with an exemplary embodiment of the disclosed account transaction management system.

FIG. 3 shows a flow chart of an exemplary process of the disclosed account transaction management method.

FIG. 4 shows an exemplary environment for implementing the method of the present disclosure.

### DETAILED DESCRIPTION

The exemplary embodiments of the disclosed method and system for account transaction management are described below. The system described herein generates a dynamic account number corresponding to a true account number (e.g., user's bank account number) of a user and sends the dynamic account number to the user. In one embodiment, multiple dynamic account numbers are generated for a single true account number and sent to the user either separately or as a group. The account can be the financial kind such as a bank account. The dynamic account number may be valid for a one-time use or set to expire after a certain period of time or a certain number of uses.

When a user needs to conduct an account transaction/operation (e.g., to exercise a fund transfer function provided by a online bank), the user uses the dynamic account number in place of the true account number to complete the transaction or operation. If the user has received multiple dynamic account numbers, the user may choose one of the dynamic account numbers to conduct the account transaction. Upon finishing the transaction, or upon a certain time or event determined by the system, the system may automatically delete or invalidate the corresponding relationship between the dynamic account number that has just been used and the true account number. This causes the dynamic account number to expire. As such, the account management system ensures this dynamic account number cannot be used again after a single use or after a certain time. As a result, even if the user loses or leaks the dynamic account number that is being used, it will not lose control of the account or bring any loss to the account. For example, if the dynamic account number that has been used and already expired is subsequently acquired through a virus, Trojans and the like, the dynamic account number cannot be illegally used to control the account by one who has process of the dynamic account number. Therefore, using these dynamic account numbers to conduct an account transaction can effectively prevent user account information from being stolen or otherwise compromise.

In one embodiment, the dynamic account number is sent to a mobile phone of the user. The dynamic account number can be sent to the user using text messaging, e-mail, regular mail, voice messaging, personal contact, or any combination thereof. Multiple dynamic account numbers can be generated in correspondence to a single true account number. These dynamic account numbers may either be pre-generated for a given account, or generated in response to a user request. The dynamic account numbers may be sent to the user one at a time or in groups.

In the following, a fund withdrawal from a bank account is used as an example to illustrate the disclosed method and system. In this description, the order in which a process is described is not intended to be construed as a limitation, and any number of the described process blocks may be combined in any order to implement the method, or an alternate method.

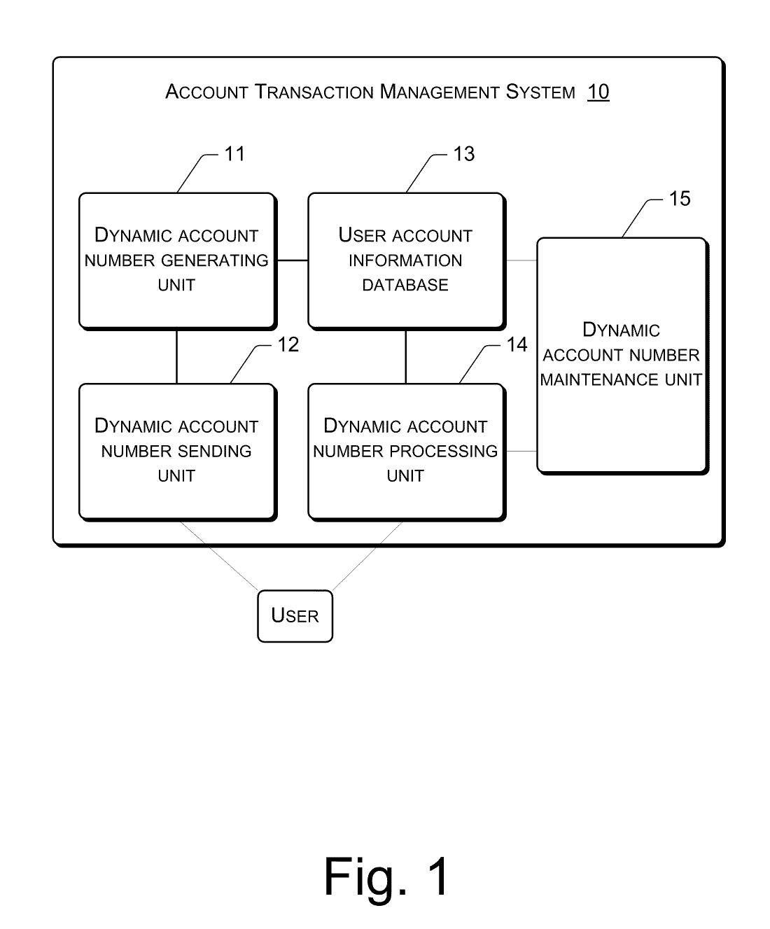

FIG. 1 shows a structural schematic diagram of an account transaction management system in accordance with an exemplary embodiment of the disclosed account management system.

The account transaction management system 10 includes a dynamic account number generating unit 11, a dynamic account number sending unit 12, a user account information database 13, a dynamic account number processing unit 14, and a dynamic account number maintenance unit 15. The dynamic account number generating unit 11 is used for generating dynamic account numbers corresponding to a true account number of a user. Either a single or multiple dynamic account numbers may be generated corresponding to a single true account number. The dynamic account numbers may be either pre-generated, or generated in response to a user request for generating dynamic account numbers. The dynamic account number sending unit 12 is used for sending the dynamic account numbers to the user or printing out the dynamic account numbers. The dynamic account numbers may be either sent electronically using communication methods such as text messaging and e-mail, or sent physically via regular mail or by personal contact after the dynamic account numbers have been printed out. If multiple dynamic account numbers are generated for a single account, these numbers may be sent to the user either one at a time or as a group together.

The user account information database 13 is used for storing corresponding relationships between the true account number and the dynamic account numbers. The dynamic account number processing unit 14 is used for conducting a transaction according to the dynamic account number provided by the user and the corresponding relationship. The dynamic account number maintenance unit 15 is used for deleting or invalidating the stored corresponding relationship between the dynamic account number and the true account number in the user account information database after the dynamic account number is used once or for a certain number of times, or after a certain preset period of time upon sending to the user.

The dynamic account number sending unit 12 embodies the dynamic account numbers generated by the dynamic account number generating unit 11 in a concrete form so that user can conveniently use these dynamic account numbers. For instance, the dynamic account number sending unit 12 may support printing or text messaging the dynamic account numbers to the user. For the printing option, the dynamic account number sending unit 12 can print the dynamic account numbers onto a password slip, a code paper or an ordinary paper and then sends the printed paper to the user by a suitable means such as mailing. For text messaging option, the dynamic account number sending unit 12 can directly send these dynamic account numbers in the form of text messages to the user's mobile phone or other electronic devices.

To perform the account transaction, user may still be required to use a password to protect the account. For example, the dynamic account number processing unit may be further adapted for receiving a password from the user and verifying the password against the account associated with the true account number before performing the account transaction. With password protection, even if the dynamic account numbers sent to the user are lost or otherwise leaked, others who do not know the password of the user account cannot take control of the account.

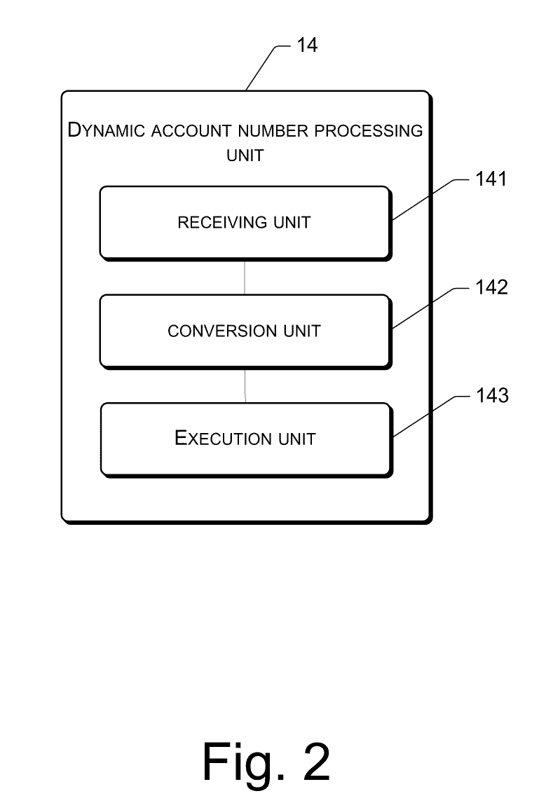

FIG. 2 shows a structural schematic diagram of a dynamic account number processing unit 14. The dynamic account number processing unit 14 includes a receiving unit 141, a conversion unit 142, and an execution unit 143. The receiving unit 141 is used for instructing the user to enter a dynamic account number, and for receiving the dynamic account number from the user. This is usually done in response to a user request. In one preferred embodiment, the account of the user is a bank account and the account transaction/operation being conducted is done directly between the user and the bank. In this embodiment, the receiving unit 141 preferably receives the dynamic account number from the user directly through a network (e.g., Internet) without going through a third-party vendor who also participates in the bank account transaction/operation.

The conversion unit 142 is used for converting the dynamic account number received by the receiving unit 141 into a corresponding true account number based upon a corresponding relationship stored in the user account information database 13. The execution unit 143 is used for receiving a password from the user and verifying the password against the user account associated with the true account number obtained by the converting unit 142. A straightforward example of password verification is done by comparing or matching the user entered password with the system-stored password of the user account. Upon successful password verification, the execution unit 113 then performs the account transaction/operation requested by the user.

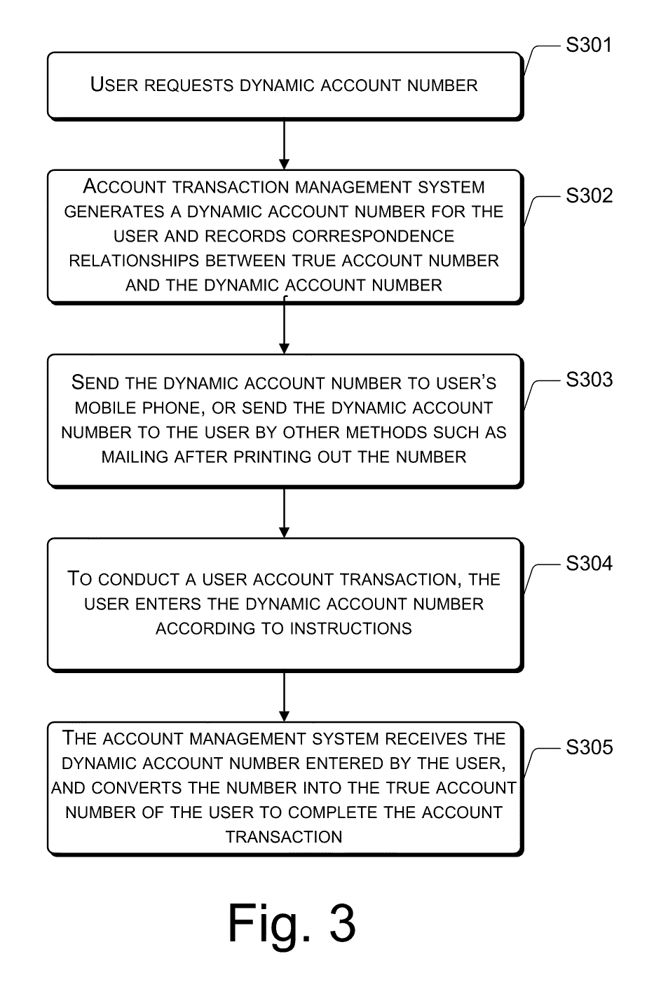

FIG. 3 shows a flow chart of an exemplary process of the disclosed account transaction management. The process is described as follows.

At block S301, a user requests a dynamic account number from an account transaction management system (e.g., 10). Typically, the user holds an account (e.g., a financial account such as a bank account) at the account transaction management system, or at another system which is accessibly connected to the account transaction management system. The account of the user is associated with a true account number.

At block S302, the account transaction management system generates a dynamic account number for the user. The dynamic account number has a corresponding relationship with the true account number. The corresponding relationship should preferably has each dynamic account number corresponding to only one true account number, although multiple dynamic account numbers may correspond to the same true account number. The account transaction management system records the corresponding relationship between the true account number of the user's account and the dynamic account numbers. One or more dynamic account numbers may be generated at this stage, depending on the system configuration and/or the user preference. The dynamic account number is preferably generated at this stage after the user has made a request for a dynamic account number, but it is appreciated that the dynamic account number may be pre-generated by the system before the user has requested, but only sent to the user upon request.

At block 303, the account transaction management system sends the dynamic account number to user's mobile phone or other electronic devices through text messaging. Alternatively, the system can print out the dynamic account number and sends the dynamic account number to the user by mail. When multiple account numbers are generated, these account numbers can be sent to the user either one at a time, or all at once as a group.

At block 304, when the user needs to perform an account transaction/operation with the account held by the user (for example, to withdraw some funds from a bank account of the user), the user sends an account transaction request to the account transaction management system and provides the dynamic account number according to the instructions of the system. If the user has multiple dynamic account numbers, the user may choose one of them and provide it according to the instructions of the system.

At block 305, upon receiving the dynamic account number from the user, the system converts this number into the true account number of the user according to the stored corresponding relationship between the dynamic account numbers and the true account number. Upon further account verification, if necessary, the system completes the requested account transaction/operation.

In one embodiment, the system requires the user to provide a password for account verification. If the password provided by the user matches with the password of the account associated with the true account number, the system performs the account transaction for the user.

In general, account verification beyond requiring a correct account number is recommended or necessary for an account transaction involving withdrawal of money or any other type of control over the account. Some transactions or operations, however, may be performed without further account verification. For example, if the requested account transaction is a deposit into the user account, the true account number of the user can be used for the deposit transaction into the corresponding account without requiring further account verification. The security of the user account would unlikely to be compromised by this type of a transaction.

After the dynamic account number has been used once (or for a certain number of times, or a certain period of time, depending on the system configuration), the corresponding relationship between this dynamic account number and the true account number is deleted or invalidated. Once the corresponding relationship is deleted or invalidated, the dynamic account number is considered expired and cannot be further used. The expiration of a dynamic account number may take place immediately after a single use, or a certain number of uses, or after a preset expiration date, depending on the system configuration.

As illustrated above, the exemplary embodiments of the disclosed method and system perform an account transaction/operation by generating one or more dynamic account numbers which have a corresponding relationship with the true account number of the user account. Even in a situation where the dynamic account number is lost or otherwise leaked, the disclosed method and system can still ensure the security of the user account, thus effectively preventing user account information from being stolen.

### Implementation Environment

It is noted that the disclosed method and system can be implemented using hardware only, but preferably should be implemented using a combination of software and hardware. The disclosed method itself can be implemented in the form of software products stored in a storage media. The software includes instructions for a computer device (either stand-alone or networked) to execute the method described in the exemplary embodiments of the current disclosure.

In particular, the above-described techniques may be implemented with the help of a computing device, such as a server or a personal computer (PC) having a computing unit, as illustrated below.

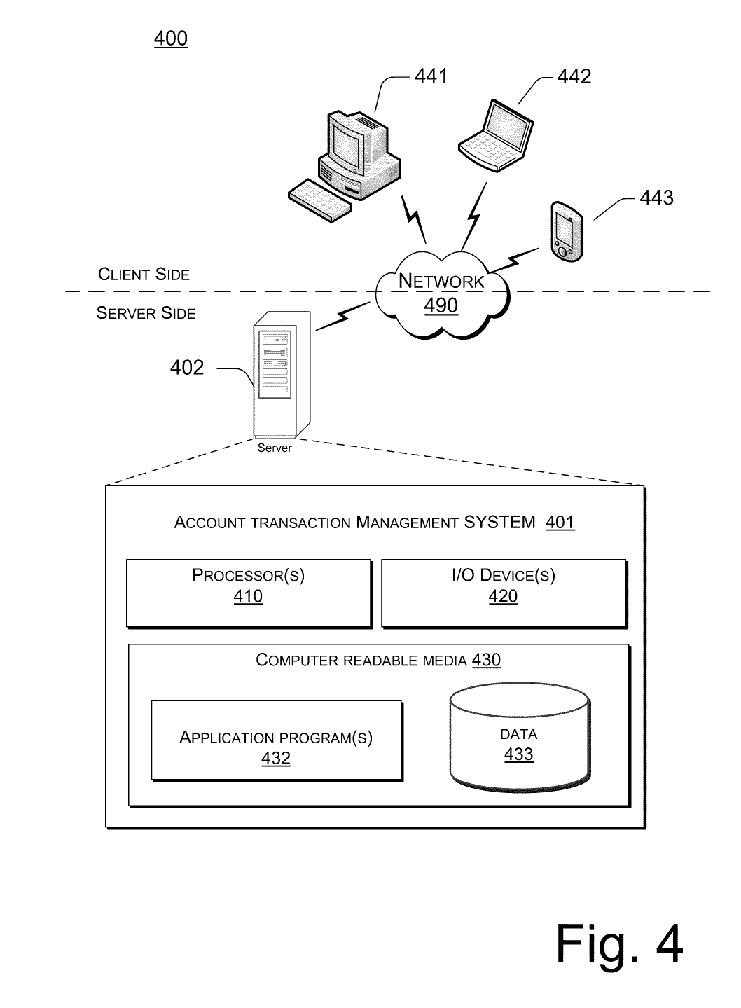

FIG. 4 shows an exemplary environment for implementing the method of the present disclosure. In illustrated system 400, some components reside on a client side and other components reside on a server side. However, these components may reside in multiple other locations. Furthermore, two or more of the illustrated components may combine to form a single component at a single location.

Account transaction management system 401 is implemented with a computing device 402 which is preferably a server and includes processor(s) 410, I/O devices 420, computer readable media 430, and network interface (not shown). The computer device 402 is connected to client-side computing devices (client terminals) such as 441, 442 and 443 through network(s) 490. In one embodiment, computing device 402 is a server described herein (e.g., server 700), while client-side computing devices 441, 442 and 443 may each be a computer or a portable device, used as a user terminal.

The computer readable media 430 stores application program modules 432 and data 434 (such as application information, account information, corresponding relationships between the dynamic account numbers and true account numbers). Application program modules 432 contain instructions which, when executed by processor(s) 410, cause the processor(s) 410 to perform actions of a process described herein (e.g., the illustrated process of FIG. 3). An exemplary process that can be performed by the account transaction management system 401 by executing instructions stored in computer readable media 430 is as follows:
generating a dynamic account number corresponding to a true account number of an account of a user,
sending the dynamic account number to the user;
storing a corresponding relationship between the true account number and the dynamic account numbers; and
conducting an account transaction according to the dynamic account number supplied by the user and the corresponding relationship.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 402 may be a server computer, or a cluster of such server computers, connected through network(s) 490, which may either be Internet or an intranet.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An account transaction management system, comprising:
a dynamic account number generating unit used for generating a dynamic account number corresponding to a true account number of an account of a user;
a dynamic account number sending unit used for sending the dynamic account number to the user or printing out the dynamic account number;
a user account information database used for storing a corresponding relationship between the true account number and the dynamic account number; and
a dynamic account number processing unit used for processing an account transaction according to the dynamic account number provided by the user and the corresponding relationship between the true account number and the dynamic account number.

2. The system as recited in claim 1, further comprising:
a dynamic account number maintenance unit used for deleting or invalidating the stored corresponding relationship between the dynamic account number and the true account number in the user account information database after the dynamic account number has been used for once or a certain number of times.

3. The system as recited in claim 1, wherein the dynamic account number sending unit sends the dynamic account number to a mobile phone of the user.

4. The system as recited in claim 1, wherein the dynamic account number sending unit sends the dynamic account number to the user through one or a combination of communication methods including text messaging, e-mail, regular mail, voice messaging, and personal contact.

5. The system as recited in claim 1, wherein the account of the user is a bank account.

6. The system as recited in claim 1, wherein the dynamic account number generating unit generates the dynamic account number in response to a user request.

7. The system as recited in claim 1, wherein the dynamic account number generating unit generates a plurality of dynamic account numbers, and the dynamic account number sending unit sends the plurality of dynamic account numbers to the user together.

8. The system as recited in claim 1, wherein the dynamic account number has a set expiration date.

9. The system as recited in claim 1, wherein the account number processing unit comprises:
a receiving unit used for receiving the dynamic account number from the user;
a conversion unit used for converting the dynamic account number received by the receiving unit into the corresponding true account number based upon the corresponding relationship stored in the user account information database; and
an execution unit used for executing the account transaction using the true account number obtained by the conversion unit.

10. The system as recited in claim 1, wherein the dynamic account number processing unit is further adapted for receiving a password from the user and verifying the password against the account associated with the true account number before performing the account transaction.

11. The system as recited in claim 1, wherein the account number processing unit receives the dynamic account number from the user directly.

12. An account transaction management method, comprising:
generating a dynamic account number corresponding to a true account number of an account of a user;
sending the dynamic account number to the user;
storing a corresponding relationship between the true account number and the dynamic account number; and
conducting an account transaction according to the dynamic account number supplied by the user and the corresponding relationship.

13. The account transaction management method as recited in claim 12, wherein, after the dynamic account number has been used for once or a certain number of times, the corresponding relationship of the dynamic account number and the true account number is deleted or invalidated.

14. The account transaction management method as recited in claim 12, wherein conducting an account transaction according to the dynamic account number supplied by the user and the corresponding relationship comprises:
converting the dynamic account number provided by the user into the true account number according to the corresponding relationship; and
conducting the account transaction for the user if a password provided by the user match that of the account.

15. The account transaction management method as recited in claim 12, wherein the dynamic account number is sent to the user through text messaging.

16. The account transaction management method as recited in claim 12, wherein the dynamic account number sending unit sends the dynamic account number to the user through one or a combination of communication methods including text messaging, e-mail, regular mail, voice messaging, and personal contact.

17. The account transaction management method as recited in claim 12, wherein the account is a bank account.

18. The account transaction management method as recited in claim 12, wherein the account is a bank account, and the account transaction comprises a fund withdrawal.

19. One or more computer-readable media storing computer-executable instructions that, when executed, perform acts comprising:
generating a dynamic account number corresponding to a true account number of an account of a user;
sending the dynamic account number to the user;
storing a corresponding relationship between the true account number and the dynamic account number; and
conducting an account transaction according to the dynamic account number supplied by the user and the corresponding relationship.

20. The one or more computer-readable media as recited in claim 19, wherein the account is a bank account, and conducting the account transaction requires the user to enter a password of the account.
